(19) United States
(12) Patent Application Publication
(10) Pub. No.: US 2013/0095309 A1
(43) Pub. Date: Apr. 18, 2013

(54) DOUBLE-SIDED PRESSURE-SENSITIVE ADHESIVE TAPE

(71) Applicants: Toshihide SUZUKI, Osaka (JP); Yoshikazu SOEDA, Osaka (JP); Noboru YOSHIDA, Osaka (JP); Takahisa MIZUTORI, Osaka (JP)

(72) Inventors: Toshihide SUZUKI, Osaka (JP); Yoshikazu SOEDA, Osaka (JP); Noboru YOSHIDA, Osaka (JP); Takahisa MIZUTORI, Osaka (JP)

(21) Appl. No.: 13/650,758

(22) Filed: Oct. 12, 2012

(30) Foreign Application Priority Data
Oct. 14, 2011 (JP) 2011-227443
Oct. 10, 2012 (JP) 2012-225397

(51) Int. Cl. C09J 7/00

(52) U.S. Cl. 428/220

(57) ABSTRACT

A double-sided pressure-sensitive adhesive tape according to an embodiment contains a solvent-type acrylic copolymer, in which the total thickness of the tape is 150 μm or less and a mass increase after being dipped in artificial sebum under an atmosphere at 55° C. for 3 days is 10% by mass or more and 150% by mass or less.

### BACKGROUND OF THE INVENTION

1. Field of the Invention

The present invention relates to a double-sided pressure-sensitive adhesive tape, and more particularly, to a double-sided pressure-sensitive adhesive tape to be used for fixing a member installed in a portable electronic device.

2. Description of the Related Art

In portable electronic devices, such as a mobile phone, PHS, digital camera, electronic organizer, portable music player, portable game console, smart phone, and tablet PC, double-sided pressure-sensitive adhesive tapes are used for the joint between a display panel provided on the surface of an image display module and a case, and used for the bonding and fixation of various members or modules, including the joint of a touch panel or LCD member.

In a mobile phone, PHS, or smart phone, an oil component, such as sebum, cosmetics, hair conditioning material, or the like, is adhered to such a device when the device is in contact with an ear or a portion around the ear or head hairs during a call, and there are sometimes the cases where the oil component gradually makes an entry, from the joint portion between the panel and the case, even into a double-sided pressure-sensitive adhesive tape, during use for a long period of time. In addition, the portable electronic devices, in which a touch panel function is provided to an image display area, have been widely used in recent years, and with the trend, there is the problem that a double-sided pressure-sensitive adhesive tape for fixing a member becomes poor in the pressure-sensitive adhesive property due to the sebum, which has entered the inside of such a portable electronic device from fingers, thereby causing peeling or swelling of the tape due to the sebum.

The thickness of each portable electronic device has been made small in recent years, and with the trend, thin double-sided pressure-sensitive adhesive tapes have been used for fixing members, and there is a demand for a touch panel member, etc., in which a change in the depth direction is small. In particular, in the fixation between the ITO film and ITO glass in a resistive touch panel, it is an important performance that a change in the depth direction is small.

An acrylic polymer in an acrylic pressure-sensitive adhesive to be used in a double-sided pressure-sensitive adhesive tape generally has a property of absorbing sebum. If an oil absorption is large, the thickness of a tape becomes large due to swelling, thereby causing a change in the thickness of a joined member. If the swelled pressure-sensitive adhesive protrudes from a fixed thickness to an image display area, or if an unevenness is caused in the changes in the depth direction, occurring in the fixation of a resistive touch panel, etc., a Newton ring is created, thereby causing a trouble in image display. Accordingly, it is preferable that a change in the depth direction is small; however, when the thickness of a tape is large, swelling occurring due to oil becomes large, and hence a change in the depth direction becomes large.

Although Patent Document 1 discloses a measure for dealing with the protrusion of a pressure-sensitive adhesive into the width direction, occurring due to sebum, a change in the depth direction is not referred to.

### PATENT DOCUMENT

[Patent Document 1] Japanese Patent Application Publication No. 2009-215355

### SUMMARY OF THE INVENTION

Therefore, a purpose of the present invention is to provide a double-sided pressure-sensitive adhesive tape in which: swelling and a change in the depth direction of the tape, occurring due to an entry of an oil component, such as sebum, are small, and hence, when used in fixation of a member in a portable electronic device even for a long period of time, a trouble in image display, such as a Newton ring, occurring due to either of the protrusion of the tape into the image display area and a change in the depth direction, which occur because of an entry of an oil component, such as human sebum, is not caused.

An embodiment of the present invention is a double-sided pressure-sensitive adhesive tape. The double-sided pressure-sensitive adhesive tape is used in an application of fixing a member in a portable electronic device. The tape contains a solvent-type acrylic copolymer, in which the total thickness of the tape is 150 μm or less and a mass increase after being dipped in artificial sebum under an atmosphere at 55° C. for 3 days is 10% by mass or more and 150% by mass or less.

In the double-sided pressure-sensitive adhesive tape according to the aforementioned embodiment, the weight average molecular weight of the solvent-type acrylic copolymer may be 400000 or more and 700000 or less. Further, when it is assumed that: a pressure-sensitive adhesive force (N/5 mm) of the double-sided pressure-sensitive adhesive tape is A, the force occurring when the tape is peeled off in the 180°-peeling off direction at a tensile speed of 300 mm/min after a lapse of 72 hours at 23° C.×50% RH, in a state of not being dipped in the artificial sebum, after being adhered to a transparent conductive film that serves as an adherend; and a pressure-sensitive adhesive force (N/5 mm) of the tape is B, the force occurring when the tape is peeled off in the 180°-peeling off direction at a tensile speed of 300 mm/min after a lapse of 1 hour at 23° C.×50% RH after the artificial sebum is wiped off, in which the tape has been dipped at 55° C. for 72 hours after being attached to a transparent conductive film that serves as an adherend, B/A may be 0.4 or larger. Furthermore, the double-sided pressure-sensitive adhesive tape may be used for adhesion of a transparent conductive film.

Appropriate combinations of the aforementioned elements can also be included in the scope of the invention that seeks patent protection by the present application.

### DETAILED DESCRIPTION OF THE INVENTION

The invention will now be described by reference to the preferred embodiments. This does not intend to limit the scope of the present invention, but to exemplify the invention.

Hereinafter, preferred embodiments of the present invention will be described. An issue, other than the issues particularly referred to in this specification and is important for carrying out the invention, can be understood as an issue designed by a person skilled in the art, based on a related art in the art. The invention can be carried out based on the content disclosed in the specification and the common general technical knowledge in the art.

A double-sided pressure-sensitive adhesive tape according to an embodiment can be used in an application of fixing a member in a portable electronic device. The double-sided pressure-sensitive adhesive tape contains a solvent-type acrylic copolymer as a pressure-sensitive adhesive composition, in which the total thickness of the tape is 150 μm or less and a mass increase after being dipped in artificial sebum under an atmosphere at 55° C. for 3 days is 10% by mass or more and 150% by mass or less.

In the double-sided pressure-sensitive adhesive tape according to the present embodiment, a mass increase (hereinafter, sometimes referred to as an oil absorption) after being dipped in artificial sebum under an atmosphere at 55° C. for 3 days is 10% by mass or more and 150% by mass or less. Although it is preferable that an oil absorption is smaller, it is difficult to prevent oil absorption of the tape, because the acrylic pressure-sensitive adhesive has a high affinity with oil. If an oil absorption is less than 10% by mass, the oil that has not been absorbed bleeds out into the adhesion interface, thereby causing the adhesiveness as a double-sided pressure-sensitive adhesive tape to be remarkably decreased. In particular, if the oil absorption is less than 0% by mass, the pressure-sensitive adhesive is eluted, and the pressure-sensitive adhesive force is decreased or the eluted pressure-sensitive adhesive protrudes into an image display area. If an elutable component is eluted into an electronic circuit, an adverse influence, such as an increase in resistance, is caused.

If an oil absorption is more than 150% by mass, the pressure-sensitive adhesive, which cannot be fit into an allowable thickness when a pressure-sensitive adhesive tape is installed in a portable electric device, protrudes into the image display area or a Newton ring is caused due to an unevenness in thickness. In addition, if the pressure-sensitive adhesive in the double-sided pressure sensitive adhesive tape absorbs an oil in an amount more than 150% by mass, the adhesive is remarkably plasticized, thereby causing a decrease in pressure-sensitive adhesive force or cohesive force, which entails peeling of the tape.

It is preferable that a change in the thickness of a double-sided pressure-sensitive adhesive tape is 20 μm or less. Although a slight margin in the depth direction is structurally provided in a portable electronic device, the margin becomes small because the thinning of portable electronic devices has been promoted in recent years. Accordingly, if a change in the thickness is larger than 20 μm, the pressure-sensitive adhesive, which cannot be fit into the installed thickness, protrudes into the image display area or a Newton ring is caused due to an unevenness in thickness.

If the total thickness of a double-sided pressure-sensitive adhesive tape is larger than 150 μm, an amount of change in thickness becomes more than 20 μm even when an oil absorption, occurring when being dipped in sebum, is small, and hence a Newton ring occurring due to a change in the depth direction or protrusion of a paste is caused. Accordingly, the total thickness of a double-sided pressure-sensitive adhesive tape is preferably 150 μm or less, and more preferably 100 μm or less.

An oil absorption is determined through the following procedures, based on a change in weight before and after a double-sided pressure-sensitive adhesive tape is dipped in sebum.

### [Method of Calculating Oil Absorption]

A double-sided pressure-sensitive adhesive tape is cut into a specimen having a size of 50 mm in width×100 mm in length, and the specimen from which the release paper on both sides have been removed is weighed (mass: Wa). Thereafter, the specimen is dipped in artificial sebum such that both the surfaces thereof are totally dipped under an atmosphere at 55° C. for 3 days. After 3-day dipping, the oil adhered to the surfaces of the double-sided pressure-sensitive adhesive tape is sufficiently wiped off by using an oil clear film (e.g., Petit Garden Oil Clear Film N made by Kanebo Cosmetics Inc.), so that a change in color in the oil clear film is not present. The specimen, the oil on the surface of which has been thus wiped off, is weighed (mass: Wb). A real oil absorption can be calculated by the following expression using these values:

Real Oil Absorption (% by mass)=[(Wb−Wa)/Wa]×100.

The artificial sebum referred to herein means one to be used as a substitute of sebum, and the components thereof are not particularly limited, as far as they have physical properties approximate to those of sebum. As the artificial sebum, a mixture including: triglyceride, such as triolein and tripalmitin; ester, such as squalene and myristyl octadecylate; and fatty acid, such as oleic acid, is preferred. As the mixing ratio, a mixture including: 5 to 50% by mass of triglyceride; 5 to 20% by mass of squalene; 5 to 50% by mass of ester; and 5 to 35% by mass of fatty acid, is preferred. Among them, an artificial sebum having the following composition is particularly preferred:

artificial sebum: 33.3% by mass of triolein; 20.0% by mass of oleic acid; 13.3% by mass of squalene; and 33.4% by mass of myristyl octadecylate.

The double-sided pressure-sensitive adhesive tape according to the embodiment contains a solvent-type acrylic copolymer. In the present specification, the “solvent-type acrylic copolymer” means an acrylic copolymer obtained by solution polymerization. The solvent-type acrylic copolymer can be obtained by copolymerization using a publicly-known polymerization method with the use of solution polymerization. In the case of an acrylic copolymer obtained by a method other than the solution polymerization, e.g., in the case of that polymerized by emulsion polymerization, the pressure-sensitive adhesive layer is eluted when being dipped in artificial sebum. Accordingly, an solvent-type acrylic copolymer is preferred as the pressure-sensitive adhesive composition. In addition, for example, if a synthesized rubber-based or natural rubber-based pressure-sensitive adhesive composition is used as the pressure-sensitive adhesive composition, instead of the solvent-type acrylic copolymer, the pressure-sensitive adhesive layer is eluted when being dipped in artificial sebum. Accordingly, a solvent-type acrylic copolymer is preferred as the pressure-sensitive adhesive composition for achieving the purpose of the present invention.

It is preferable to select monomers that form the solvent-type acrylic copolymer such that the glass transition temperature of the acrylic copolymer is within a range of −56° C. to −20° C. By adjusting the glass transition temperature of the solvent-type acrylic copolymer to be within this range, pressure-sensitive adhesive force and tackiness, which are basic pressure-sensitive adhesive properties required for a double-sided pressure-sensitive adhesive tape, and an anchoring property onto a rough surface represented by a foam to be used as an adherend, can be all satisfied.

Herein, Tg (glass transition temperature) means a value determined from FOX Equation, based on both Tg of a homopolymer obtained from each monomer that forms a monomer material and the mass fraction (copolymerization ratio) of the monomer. As Tg of a homopolymer, a value described in “Pressure-Sensitive Adhesive Technology Handbook” by NIKKAN KOGYO SHIMBUN, LTD., or “Polymer Handbook” by Wiley-Interscience, which are both publicly-known documents, is adopted. For example, as Tg of each of the homopolymers in the technique disclosed herein, −70° C., −54° C., 8° C., 105° C., 66° C., 32° C., 106° C., and 228° C. are respectively adopted for 2-ethylhexyl acrylate, butyl acrylate, methyl acrylate, methyl methacrylate, cyclohexyl methacrylate, vinyl acetate, acrylic acid, and methacrylic acid. As Tg of a homopolymer in the monomers that is not disclosed in the aforementioned publicly-known documents, a value determined by the following method is adopted. That is, a target monomer is subjected to solution polymerization to synthesize a homopolymer having an average degree of polymerization of 5×10⁴ to 10×10⁴; a test sample is produced by casting the obtained homopolymer onto a release liner and drying it; differential scanning calorimeter measurement is performed on the obtained test sample by using a differential scanning calorimeter (DSC): type “DSC 6220” made by SII Nano Technology Inc., by changing the temperature of the sample from −80° C. to 280° C. at a rate of tempera increase of 10° C./min; and the initial endothermic starting temperature is adopted as Tg of the homopolymer.

If the glass transition temperature of the solvent-type acrylic copolymer is lower than −56° C., cohesive force becomes insufficient, thereby causing a paste to remain when a tape is peeled off after being attached for a long period of time. Conversely, if the glass transition temperature of the solvent-type acrylic copolymer is higher than −20° C., the pressure-sensitive adhesive force to an adherend is decreased, or the attaching property to a curved surface is decreased.

It is preferable that, in the monomers that form the solvent-type acrylic copolymer, the content of (meth)acrylic acid alkyl ester having a C₁₋₄ alkyl group is 80.0% by mass or more; that of radically polymerizable monomer having at least one carboxyl group is 0.5 to 10.0% by mass; and that of other copolymerizable monomers is 19.5% by mass or less. When the content of (meth)acrylic acid alkyl ester having a C₁₋₄ alkyl group in the monomers that form the solvent-type acrylic copolymer is 80.0% by mass or more, an oil absorption can be adjusted to be within a range of 10 to 150% by mass. It is more preferable that, in the monomers that form the solvent-type acrylic copolymer, the content of the (meth)acrylic acid alkyl ester having a C₁₋₄ alkyl group is 90.0% by mass or more; that of the radically polymerizable monomer having at least one carboxyl group is 0.5 to 10.0% by mass; and that of other copolymerizable monomers is 9.5% by mass or less. Herein, the “(meth)acrylic” means “acrylic” and “methacrylic”.

Examples of the (meth)acrylic acid alkyl ester having a C₁₋₄ alkyl group include: (meth)acrylic acid methyl, (meth)acrylic acid ethyl, (meth)acrylic acid isopropyl, (meth)acrylic acid propyl, (meth)acrylic acid n-butyl, (meth)acrylic acid isobutyl, and (meth)acrylic acid t-butyl, etc. These esters can be used alone or in combination of two or more thereof. Acrylic acid methyl, acrylic acid ethyl, and acrylic acid n-butyl are used more preferably; and acrylic acid methyl and acrylic acid n-butyl are used still more preferably.

It is preferable that, in the solvent-type acrylic copolymer, the content of the radically-polymerizable monomer having at least one carboxyl group, as a functional group to be involved in the reaction with the later-described cross-linking agent, is within a range of 0.5 to 10.0% by mass.

Specific examples of the radically-polymerizable monomer having at least one carboxyl group include for example: (meth)acrylic acid, itaconic acid anhydride, itaconic acid, crotonic acid, maleic anhydride, maleic acid, 2-(meth)-acryloyloxyethyl succinic acid, 2-acryloyloxyethyl phthalic acid, and 2-(meth)-acryloyloxyethylhexahydrophthalic acid, etc. These monomers can be used alone or in combination of two or more thereof. Acrylic acid can be preferably used.

The amount of the radically-polymerizable monomer having at least one carboxyl group is preferably within a range of 0.5 to 10.0% by mass, based on 100% by mass of the whole monomers. When the amount of the radically-polymerizable monomer having at least one carboxyl group is 0.5% by mass or more, the carboxyl group-containing monomer can sufficiently fulfill the function as a cross-linking point in the obtained polymer, thereby allowing a decrease in the pressure-sensitive adhesive force of the pressure-sensitive adhesive layer to be suppressed and allowing the paste to hardly remain when the tape is peeled off after being attached for a long period of time. Solution stability as an aqueous dispersion type pressure-sensitive adhesive is in the trend of being decreased. On the other hand, when the amount of the radically-polymerizable monomer having at least one carboxyl group is 10.0% by mass or less, it can be suppressed that: the glass transition temperature may be too high; the pressure-sensitive adhesive force to an adherend may be decreased; and the attaching property to a curved surface may be decreased.

Another monomer that can be copolymerized with the aforementioned monomers that form the solvent-type acrylic copolymer, includes a compound having a polymerizable double bond within its molecule, which is referred to as α,β-unsaturated compound. An acrylic monomer can be preferably used from the viewpoints of copolymerizability and pressure-sensitive adhesive physical property. Examples of the acrylic monomer include, for example: (meth)acrylic acid alkyl esters, such as (meth)acrylic acid 2-ethylhexyl, (meth)acrylic acid octyl, (meth)acrylic acid isooctyl, (meth)acrylic acid nonyl, (meth)acrylic acid isononyl, (meth)-acrylic acid n-amyl, (meth)acrylic acid isoamyl, (meth)acrylic acid n-hexyl, (meth)acrylic acid decyl, (meth)acrylic acid dodecyl, (meth)acrylic acid octadecyl, (meth)acrylic acid lauryl, and (meth)acrylic acid stearyl; (meth)acrylic acid cyclic esters, such as (meth)acrylic acid cyclohexyl, (meth)acrylic acid benzyl, (meth)acrylic acid isobornyl, (meth)acrylic acid phenyl, and (meth)acrylic acid phenoxy ethyl; unsaturated group-containing (meth)acrylic acid esters, such as (meth)acrylic acid allyl, (meth)acrylic acid 1-methylallyl, (meth)acrylic acid 2-methylallyl, (meth)acrylic acid 1-butenyl, (meth)acrylic acid 2-butenyl, (meth)acrylic acid 3-butenyl, (meth)acrylic acid 1,3-dimethyl-3-butenyl, (meth)acrylic acid 2-chloroallyl, (meth)acrylic acid 3-chloroallyl, (meth)acrylic acid o-allylphenyl, (meth)acrylic acid 2-(allyloxy)ethyl, (meth)acrylic acid allyllactyl, (meth)acrylic acid citronellyl, (meth)acrylic acid geranyl, (meth)acrylic acid rhodinyl, (meth)acrylic acid cinnamyl, and (meth)acrylic acid vinyl; heterocyclic-containing (meth)acrylic acid esters, such as (meth)acrylic acid glycidyl, (meth)acrylic acid (3,4-epoxycyclohexyl)methyl, and (meth)acrylic acid tetrahydrofurfuryl; amino group-containing (meth)acrylic acid esters, such as (meth)acrylic acid N-methylamino ethyl, (meth)acrylic acid N-tributyl aminoethyl, (meth)acrylic acid N,N-dimethylaminoethyl, and (meth)acrylic acid N,N-diethyl aminoethyl; alkoxy silyl group-containing (meth)acrylic acid esters, such as 3-methacryloxypropyltrimethoxysilane, 3-methacryloxypropyltriethoxysilane, 3-methacryloxypropyltriisopropoxysilane, 3-methacryloxypropylmethyldimethoxysilane, and 3-methacryloxypropylmethyldiethoxysilane; (meth)acrylic acid derivatives, such as (meth)acrylic acid methoxyethyl and ethyleneoxide adduct of (meth)acrylic acid; (meth)acrylic acid perfluoro alkyl esters, such as (meth)acrylic acid perfluoroethyl, (meth)acrylic acid perfluoropropyl, (meth)acrylic acid perfluorobutyl, and (meth)acrylic acid perfluorooctyl; polyfunctional(meth)acrylic acid esters, such as tri(meth)acrylic acid trimethylolpropane, tri(meth)acrylic acid pentaerythritol, diacrylic acid 1,1,1-tris(hydroxymethyl)ethane, tri acrylic acid 1,1,1-tris(hydroxymethyl)ethane, and 1,1,1-tris(hydroxymethyl)propane trisacrylic acid; and fluorine-containing (meth)acrylic acid esters, such as (meth)acrylic acid perfluoromethyl, (meth)acrylic acid trifluoromethylmethyl, (meth)acrylic acid 2-trifluoromethylethyl, (meth)acrylic acid diperfluoromethylmethyl, (meth)acrylic acid 2-perfluoroethylethyl, (meth)acrylic acid 2-perfluoromethyl-2-perfluoro ethylmethyl, (meth)acrylic acid triperfluoromethylmethyl, (meth)acrylic acid 2-perfluoroethyl-2-perfluorobutylethyl, (meth)acrylic acid 2-perfluorohexylethyl, (meth)acrylic acid 2-perfluorodecylethyl, and (meth)acrylic acid 2-perfluorohexadecylethyl. However, the acrylic monomer is not particularly limited thereto. These acrylic monomers maybe used alone or in combination of them.

Also, other monomers, such as a vinyl monomer that can be copolymerized with the acrylic monomer, can be used. Examples of the other monomers include, for example: aromatic vinyl monomers, such as styrene, α-methylstyrene, β-methylstyrene, o-methylstyrene, m-methylstyrene, p-methylstyrene, 1-butylstyrene, chlorostyrene, and styrene sulfonic acid and sodium salt thereof; trialkyloxysilyl group-containing vinyl monomers, such as vinyltrimethoxysilane and vinyltriethoxysilane; silicon-containing vinyl monomers, such as γ-(methacryloyloxypropyl)trimethoxysilane; nitrile group-containing vinyl monomers, such as acrylonitrile and methacrylonitrile; amide group-containing vinyl monomers, such as acrylamide and methacrylamide; vinyl esters, such as vinyl acetate, vinyl propionate, vinyl pivalate, vinyl benzoate, and vinyl cinnamate; and fluorine-containing monomers, such as perfluoroethylene, perfluoropropylene, and vinylidene fluoride. However, the other monomers are not particularly limited thereto. These other monomers can be used alone or in combination of two or more thereof. Vinyl acetate can be preferably used.

In the (meth)acrylic acid alkyl esters each including an alkyl group having eight or more of carbons, such as (meth)acrylic acid 2-ethylhexyl, (meth)acrylic acid octyl, (meth)acrylic acid isooctyl, (meth)acrylic acid nonyl, and (meth)acrylic acid isononyl, an oil absorption is increased, and hence it is preferable that the content thereof is 10% by mass or less, and more preferable that such a (meth)acrylic acid alkyl ester is not contained.

Examples of the initiator to be used in the aforementioned polymerization method include, for example: oil-soluble azo initiators, such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2-2′-azobis(2,4,4-trimethylpentane), and dimethyl 2,2′-azobis(2-methylpropionate); and oil-soluble peroxide initiators, such as benzoyl peroxide, t-butyl hydroperoxide, di-t-butyl peroxide, t-butyl peroxybenzoate, dicumyl peroxide, 1,1-bis(t-butyl peroxide)-3,3,5-trimethylcyclohexane, and 1,1-bis(t-butyl peroxide)cyclododecane. These initiators can be used alone or in combination of two or more thereof. The amount of these initiators may be one typically used in the aforementioned polymerization method and is, for example, within a range of 0.01 to 1.0% by mass based on 100% by mass of the monomers.

Also, a chain transfer agent can be used in the aforementioned polymerization, in order that the obtained polymer has a suitable molecular weight. Examples of the chain transfer agent include commonly-used ones, such as, for example: lauryl mercaptan, glycidyl mercaptan, 2-mercaptoethanol, mercapto acetic acid, 2-ethylhexyl thioglycolate, 2,3-dimercapto-1-propanol, and α-methylstyrene dimer. These chain transfer agents can be used alone or in combination of two or more thereof. The use amount of the chain transfer agent may be one typically used in the aforementioned polymerization method and is, for example, within a range of approximately 0.01 to 15% by mass based on 100% by mass of the monomers.

The weight average molecular weight of the solvent-type acrylic copolymer is preferably within a range of 400000 to 700000. When the weight average molecular weight thereof is 400000 or more, it can be suppressed that the cohesive force of the pressure-sensitive adhesive layer may be likely to be decreased, thereby allowing the paste to hardly remain when the tape is peeled off after being attached for a long period of time. When the weight average molecular weight thereof is 700000 or less, it can be suppressed that: the cohesive force of the pressure-sensitive adhesive layer becomes too large; the pressure-sensitive adhesive force to an adherend may be decreased; and the attaching property to a curved surface may be decreased. The weight average molecular weight of the solvent-type acrylic copolymer is more preferably within a range of 400000 to 650000, and still more preferably within a range of 400000 to 600000.

The weight average molecular weight described herein means the polystyrene-converted weight average molecular weight of a soluble matter in the obtained acrylic copolymer, the soluble matter being acquired by extracting a non-volatile matter in the acrylic copolymer with tetrahydrofuran (hereinafter, THF) and the polystyrene-converted molecular weight being determined by GPC measurement.

It is preferable that the gel fraction of the pressure-sensitive adhesive composition included in the double-sided pressure-sensitive adhesive tape is within a range of 20 to 90%. When the gel fraction thereof is 20% or more, the cohesive force is further improved and it can be further suppressed that the pressure-sensitive adhesive composition may be eluted when dipped in artificial sebum. Further, when the gel fraction thereof is 90% or less, the pressure-sensitive adhesive force to an adherend can be improved and the attaching property to a curved surface can be further improved. The gel fraction of the pressure-sensitive adhesive composition is more preferably within a range of 20 to 70%, and still more preferably within a range of 20 to 60%.

The gel fraction described herein means the mass fraction of an insoluble matter, which remains after a non-volatile matter, obtained after the aqueous dispersion type pressure-sensitive adhesive composition is dried, is extracted with ethyl acetate; and is calculated by the following method: approximately 0.1 g of a pressure-sensitive adhesive, which is obtained by being coated on a release liner and dried, is enveloped with a Teflon (registered trademark) sheet (product name: “NTF1122” made by NITTO DENKO CORPORATION) and tied with a kite string; the package is placed into a 50 ml-container filled with ethyl acetate at a ratio of one package in one container, which is left uncontrolled at room temperature for one week; thereafter, the Teflon sheet is taken out from the container and the mass of the sample is measured after the ethyl acetate is removed by drying the sheet in a drier at 130° C. for 2 hours; and the gel fraction is calculated by the following expression:

gel fraction (%)={(total mass of Teflon, kite string, and gel, after being dried)−(total mass of Teflon and kite string, at initial stage)}/{(total mass of Teflon, kite string, and pressure-sensitive adhesive, at initial stage)-(total mass of Teflon and kite string, at initial stage)}×100.

A method of increasing the gel fraction of the pressure-sensitive adhesive composition is not particularly limited, but, for example, addition of a cross-linking agent to the polymer can be adopted. The cross-linking agent is not particularly limited, but conventionally- and publicly-known cross-linking agents can be used. Examples of the cross-linking agent include, for example: epoxy cross-linking agents, such as polyethylene glycol diglycidyl ether, isocyanate cross-linking agents, oxazoline cross-linking agents, aziridine cross-linking agents, hydrophilically treated carbodiimide cross-linking agents, activated methylol cross-linking agents, activated alkoxy methyl cross-linking agents, metal chelate cross-linking agents, and silane coupling agent. These cross-linking agents can be used alone or in combination of two or more thereof. The use amount of the cross-linking agent is usually within a range of 0.001 to 10 parts by mass, and preferably within a range of 0.001 to 5 parts by mass, based on 100 parts by mass of the polymer.

A tackifier resin may be added to the pressure-sensitive adhesive composition. As such a tackifier, one or more types of tackifying resins selected from various tackifying resins consisting of, for example, rosin resins, rosin derivative resins, petroleum resins, terpene resins, phenol resins, and ketone resins, etc., can be used. The use amount of the tackifies is within a range of 10 to 50% by mass, and preferably within a range of 15 to 40% by mass, based on 100% by mass of the solvent-type acrylic copolymer.

Subsequently, specific aspects of the double-sided pressure-sensitive adhesive tape according to the embodiment will be described. A double-sided pressure-sensitive adhesive tape according to a first aspect has a multilayer structure in which a pressure-sensitive adhesive layer formed of the aforementioned pressure-sensitive adhesive composition is laminated on each of the surfaces of a non-release sheet-shaped substrate (pressure-sensitive adhesive layer/non-release sheet-shaped substrate/pressure-sensitive adhesive layer). Herein, a release sheet-shaped substrate is laminated on the pressure-sensitive adhesive surface of each of the pressure-sensitive adhesive layers in the double-sided pressure-sensitive adhesive tape before used. A double-sided pressure-sensitive adhesive tape according to second aspect has a single-layer structure, which is a so-called core-less structure and is formed only of a pressure-sensitive adhesive layer. A release sheet-shaped substrate is laminated on the pressure-sensitive adhesive surface of each of the pressure-sensitive adhesive layers in the double-sided pressure-sensitive adhesive tape before used.

Examples of the non-release sheet-shaped substrate include, for example: plastic films made of plastics, such as polyolefin resins including polyethylene, polyester resins including polyethylene terephthalate, vinyl acetate resins, polyimide resins, fluorine resins, and cellophane; paper, such as craft paper and Japanese paper; rubber sheets made of natural rubber or butyl rubber, etc.; foam sheets made by foaming polyurethane or polychloroprene rubber, etc.; metallic foils, such as aluminum foil and copper foil; and complexes of them, etc. In addition, a surface treatment, such as corona treatment, may be performed on one or both surfaces of these substrates.

The release sheet-shaped substrate is also referred to as a separator, and examples of such a release sheet-shaped substrate include, for example: paper on which a film, such as glassine paper, craft paper, clay coated paper, polyethylene, or the like, is laminated; paper on which a resin, such as polyvinyl alcohol, acrylic ester copolymer, or the like, is coated; laminated bodies obtained by laminating a releasing agent, such as fluorine resin, silicone resin, or the like, on a synthetic resin film, such as polyester, polypropylene, or the like. However, the release sheet-shaped substrates are not particularly limited.

When the release sheet-shaped substrates are laminated on both the surfaces of the pressure-sensitive adhesive layer in the double-sided pressure-sensitive adhesive tape, it is preferable, from the viewpoint of improving workability, to select each of the release sheet-shaped substrates such that the release force for one of the substrates to be laminated on both the surface thereof is different from that of the other. For example, workability is improved by selecting the release sheet-shaped substrate, which is to be first attached to one surface of the double-sided pressure-sensitive adhesive tape, so that the release force is smaller than that for the other release sheet-shaped substrate to be subsequently attached to the other surface of the tape.

The double-sided pressure-sensitive adhesive tape according to the embodiment can be obtained by various methods. The tape can be obtained, for example, in the following way, in which: a pressure-sensitive adhesive solution is coated on one surface of the non-release sheet-shaped substrate and dried, and thereafter the release sheet-shaped substrate is overlapped on the surface of the formed pressure-sensitive adhesive layer; alternatively, a pressure-sensitive adhesive solution is coated on one surface of the release sheet-shaped substrate and is dried, and thereafter the non-release sheet-shaped substrate is overlapped on the surface of the formed pressure-sensitive adhesive layer.

A coating applicator to be used in coating the pressure-sensitive adhesive onto the sheet-shaped substrate is a commonly-used one and is not particularly limited. Examples of the coating applicator include, for example, a roll knife coater, die coater, roll coater, bar coater, gravure roll coater, reverse roll coater, dipping, and blade coater, etc.

A drying condition is not particularly limited, as far as, under the condition, the solvent and remaining monomers in the pressure-sensitive adhesive solution are dried and removed while being dried and the functional group included in the solvent-type acrylic copolymer reacts with a cross-linking agent to form a cross-linking structure. A drying condition in which, for example, temperature is within a range of 60 to 120° C. and drying time is within a range of 1 to 5 minutes is preferred, but not limited thereto. The cross-linking reaction can be further promoted by aging the pressure-sensitive adhesive layer in a state of being sandwiched with the sheet-shaped substrates after the layer is dried.

The double-sided pressure-sensitive adhesive tape can be provided in a roll form or a sheet form, or the tape can be processed into various shapes.

In the double-sided pressure-sensitive adhesive tape according to the embodiment, when it is assumed that: a pressure-sensitive adhesive force (N/5 mm) of the double-sided pressure-sensitive adhesive tape is A, the force occurring when the tape is peeled off in the 180°-peeling off direction at a tensile speed of 300 mm/min after a lapse of 72 hours at 23° C.×50% RH, in a state of not being dipped in the artificial sebum, after being adhered to a transparent conductive film that serves as an adherend; and a pressure-sensitive adhesive force (N/5 mm) of the tape is B, the force occurring when the tape is peeled off in the 180°-peeling off direction at a tensile speed of 300 mm/min after a lapse of 1 hour at 23° C.×50% RH after the artificial sebum is wiped off, in which the tape has been dipped at 55° C. for 72 hours after being attached to a transparent conductive film that serves as an adherend, B/A is preferably 0.4 or larger. When B/A is 0.4 or larger, sufficient pressure-sensitive adhesive force can be maintained, even if an oil component, such as sebum, makes an entry.

In the double-sided pressure-sensitive adhesive tape according to the embodiment, swelling and the change in the depth direction, occurring due to an entry of an oil component, such as sebum, can be improved more remarkably than those in conventional double-sided pressure-sensitive adhesive tapes. Accordingly, the tape can be particularly and preferably used for the adhesion of a transparent conductive film, such as a touch panel. By using the double-sided pressure-sensitive adhesive tape according to the embodiment for the adhesion thereof, a change in the depth direction, including the transparent conductive film, can be made small, even when the tape is used for a long period of time, and accordingly a decrease in the accuracy of touch detection by the transparent conductive film can be suppressed.

### EXAMPLES

Hereinafter, Examples will be described, in which the structures and advantages of the embodiment are indicated in detail, but the present invention is not limited thereto. Unless otherwise indicated, “part (s)” and “%” described in Examples mean “par(s) by mass” and “% by mass”, respectively.

### (Acrylic Copolymer I)

After 2.9 parts by mass of acrylic acid, 5 parts by mass of vinyl acetate, 92 parts by mass of acrylic acid butyl, 0.1 parts by mass of hydroxyethyl acrylate, and as polymerization solvents, 30 parts by mass of ethyl acetate and 120 parts by mass of toluene, were placed into a reactor provided with a stirrer, reflux cooling pipe, thermometer, dropping device, and nitrogen inlet pipe, they were stirred for 2 hours while nitrogen gas was being introduced. After the oxygen in the polymerization system was removed in such a way, 0.2 parts by mass of AIBN (2,2′-azobisisobutyronitrile) were added and the mixture was heated to 60° C. to perform a polymerization reaction for 6 hours. The solid content of the obtained polymer was 40.0% and the weight average molecular weight thereof was 500,000.

### (Acrylic Copolymer II)

After 5 parts by mass of acrylic acid, 95 parts by mass of acrylic acid butyl, and 150 parts by mass of toluene as a polymerization solvent were placed into a reactor provided with a stirrer, reflux cooling pipe, thermometer, dropping device, and nitrogen inlet pipe, they were stirred for 2 hours while nitrogen gas was being introduced. After the oxygen in the polymerization system was removed in such a way, 0.2 parts by mass of benzoyl peroxide were added and the mixture was heated to 60° C. to perform a polymerization reaction for 6 hours. The solid content of the obtained polymer was 40.0% and the weight average molecular weight thereof was 600,000.

### (Acrylic Copolymer III)

After 3 parts by mass of acrylic acid, 70 parts by mass of acrylic acid butyl, 27 parts by mass of 2-ethylhexyl acrylate, 0.05 parts by mass of 4-hydroxy butyl acrylate, and 135 parts by mass of toluene as a polymerization solvent, were placed into a reactor provided with a stirrer, reflux cooling pipe, thermometer, dropping device, and nitrogen inlet pipe, they were stirred for 2 hours while nitrogen gas was being introduced. After the oxygen in the polymerization system was removed in such a way, 0.1 parts by mass of AIBN (2,2′-azobisisobutyronitrile) were added and the mixture was heated to 60° C. to perform a polymerization reaction for 6 hours. The solid content of the obtained polymer was 42.5% and the weight average molecular weight thereof was 400,000.

### (Acrylic Copolymer IV)

After 10 parts by mass of acrylic acid, 90 parts by mass of 2-ethylhexyl acrylate, and 190 parts by mass of ethyl acetate as a polymerization solvent, were placed into a reactor provided with a stirrer, reflux cooling pipe, thermometer, dropping device, and nitrogen inlet pipe, they were stirred for 2 hours while nitrogen gas was being introduced. After the oxygen in the polymerization system was removed in such a way, 0.6 parts by mass of benzoyl peroxide were added and the mixture was heated to 60° C. to perform a polymerization reaction for 6 hours. The solid content of the obtained polymer was 34.4% and the weight average molecular weight thereof was 1,200,000.

### (Acrylic Copolymer V)

After distilled water and 0.1 parts by mass of an emulsifier (product name: “LATEMUL E-118B” made by Kao Corporation; hereinafter, simply referred to as an “emulsifier”) were placed into a reactor provided with a stirrer, reflux cooling pipe, thermometer, dropping device, and nitrogen inlet pipe, nitrogen substitution was performed by stirring them at 60° C. for 1 hour or longer, while nitrogen gas was being introduced. To the reactor, 0.1 parts by mass of 2,2′-azobis[N-(2-carboxyethyl)-2-methylpropionamidine]hydrate (product name: “VA-057” made by Wako Pure Chemical Industries, Ltd.) were added. This mixture was maintained at 60° C., and a monomer emulsion was gradually dripped thereto in 4 hours to promote an emulsion polymerization reaction. As the monomer emulsion, a mixture, which was obtained by adding 85 parts by mass of 2-ethylhexyl acrylate, 13 parts by methyl acrylate, 1.25 parts by mass of acrylic acid, 0.75 parts by mass of methacrylic acid, 0.020 parts by mass of 3-methacryloxy propyl trimethoxy silane (product name: “KBM-503” made by Shin-Etsu Chemical Co., Ltd.), 0.03 parts by mass of dodecanethiol, and 1.9 parts by mass of an emulsifier to distilled water and emulsifying them, was used. After the monomer emulsion was dripped, the mixture was further maintained at 60° C. for 3 hours and then the heating was stopped. Subsequently, 0.75 parts by mass of 10%-hydrogen peroxide solution were added per 100 parts by mass of the monomers, and 5 minutes later, 0.5 parts by mass of ascorbic acid were added per 100 parts by mass of the monomers. After the mixture was cooled to room temperature, the pH of the mixture was adjusted to 7.2 by adding 10%-aqueous ammonia to obtain an acrylic polymer emulsion having a solid content of 57%. The weight average molecular weight of the sol was 530,000.

### (Rubber Pressure-Sensitive Adhesive I)

After 100 g of SIS block copolymer (product name: “JSR SIS5505P” made by JSR SHELL ELASTOMER KK, solid content: 100%), 90 g of a petroleum resin (product name: “Quintone C200S” made by ZEON CORPORATION, solid content: 100%), 10 g of terpene resin (product name “YS RESIN TO-L” made by YASUHARA CHEMICAL CO., LTD., solid content: 100%), and 300 g of toluene were placed into a reactor provided with a stirrer, reflux cooling pipe, thermometer, dropping device, and nitrogen inlet pipe, they were stirred at 60° C. for 5 hours to produce a pressure-sensitive adhesive solution having a solid content of 40%.

### Example 1

After 100 g of the acrylic copolymer I, 4 g of rosin resin (product name: “PENCEL D-125” made by Arakawa Chemical Industries, Ltd., solid content: 100%), 4 g of rosin resin (product name: “Super ester A-100” made by Arakawa Chemical Industries, Ltd., solid content: 100%), 2 g of rosin resin (product name: “Foralyn 8020F” made by Eastman Chemical Company, and 6 g of terpene phenol resin (product name: “Tamanol 803L” made by Arakawa Chemical Industries, Ltd., solid content: 100%) were added, they were fully stirred before the resins were dissolved. To this adjusted pressure-sensitive adhesive solution, 1.1 g of aromatic polyisocyanate (product name: “CORONATE L” made by NIPPON POLYURETHANE INDUSTRY CO., LTD., solid content: 75%) were added and fully stirred. After this solvent-type pressure-sensitive adhesive solution (pressure-sensitive adhesive 1) was coated onto one surface of a PET separator (product name: “Diafoil MRF38” made by Mitsubishi Plastics Inc., thickness: 38 μm), the surface being treated with silicone, so that the dried coating thickness was 34 μm, the coated layer was dried at 100° C. for 2 minutes and a film substrate made of polyester (product name: “Lumirror #12S10” made by TORAY INDUSTRIES having a thickness of 12 μm) was then attached to the pressure-sensitive adhesive surface to obtain a product 1.

Subsequently, the aforementioned pressure-sensitive adhesive 1 was coated onto one surface of a PET separator (product name: “#75 Cerapeel MDA (S)” made by TORAY ADVANCED FILM CO., LTD., having a thickness of 75 μm), the surface being treated with silicone, so that the dried coating thickness was 34 μm, and the coated layer was then dried at 100° C. for 2 minutes. Thereafter, the PET substrate surface of the product 1 was attached to this pressure-sensitive adhesive surface to produce a double-sided pressure-sensitive adhesive tape having a total thickness of 80 μm. The obtained double-sided pressure-sensitive adhesive tape was left uncontrolled under an atmosphere of 50° C. for 24 hours and then evaluated.

### Example 2

A double-sided pressure-sensitive adhesive tape having a total thickness of 60 μm was produced in the same way as in Example 1, except that: a pressure-sensitive adhesive, obtained by adding 1.0 g of aromatic polyisocyanate (product name: “CORONATE L” made by NIPPON POLYURETHANE INDUSTRY CO., LTD., solid content: 75%) to 100 g of the acrylic copolymer I, was used; a film substrate (product name: “Lumirror #5AF53” made by TORAY INDUSTRIES having a thickness of 5 μm) was used as a substrate; and the pressure-sensitive adhesive was coated such that the dried coating thickness on both surfaces was 27.5 μm.

### Example 3

A double-sided pressure-sensitive adhesive tape having a total thickness of 60 μm was produced in the same way as in Example 2, except that a pressure-sensitive adhesive, obtained by adding 0.5 g of aromatic polyisocyanate (product name: “CORONATE L” made by NIPPON POLYURETHANE INDUSTRY CO., LTD., solid content: 75%) to 100 g of the acrylic copolymer II, was used.

### Example 4

A double-sided pressure-sensitive adhesive tape having a total thickness of 60 μm was produced in the same way as in Example 2, except that a pressure-sensitive adhesive, obtained by adding 8 g of terpene phenol resin (product name: “YS Polystar S-145” made by YASUHARA CHEMICAL CO., LTD., solid content: 100%) and 1.6 g of aromatic polyisocyanate (product name: “CORONATE L” made by NIPPON POLYURETHANE INDUSTRY CO., LTD., solid content: 75%) to 100 g of the acrylic copolymer II, was used.

### Example 5

A double-sided pressure-sensitive adhesive tape having a total thickness of 60 μm was produced in the same way as in Example 1, except that a pressure-sensitive adhesive, obtained by adding 8 g of terpene phenol resin (product name: “YS Polystar S-145” made by YASUHARA CHEMICAL CO., LTD., solid content: 100%) and 0.02 g of an epoxy cross-linking agent (product name: “TETRAD-C” made by MITSUBISHI GAS CHEMICAL COMPANY, INC., solid content: 100%) to 100 g of the acrylic copolymer II, was used.

### Comparative Example 1

A double-sided pressure-sensitive adhesive tape having a total thickness of 80 μm was produced in the same way as in Example 1, except that: a pressure-sensitive adhesive, obtained by adding 4 g of rosin resin (product name: “PENCEL D-125” made by Arakawa Chemical Industries, Ltd., solid content: 100%), 12.8 g of terpene phenol resin (product name: “YS Polystar S-145” made by YASUHARA CHEMICAL CO., LTD., solid content: 100%), and 1.1 g of aromatic polyisocyanate (product name: “CORONATE L” made by NIPPON POLYURETHANE INDUSTRY CO., LTD., solid content: 75%) to 100 g of the acrylic copolymer III, was used; a film substrate (product name: “Lumirror #25S105” made by TORAY INDUSTRIES having a thickness of 25 μm) was used as a substrate; and the pressure-sensitive adhesive was coated such that the dried coating thickness on both surfaces was 27.5 μm.

### Comparative Example 2

A double-sided pressure-sensitive adhesive tape having a total thickness of 60 μm was produced in the same way as in Example 2, except that a pressure-sensitive adhesive, obtained by adding 0.5 g of aromatic polyisocyanate (product name: “CORONATE L” made by NIPPON POLYURETHANE INDUSTRY CO., LTD., solid content: 75%) to 100 g of the acrylic copolymer IV, was used.

### Comparative Example 3

A double-sided pressure-sensitive adhesive tape having a total thickness of 60 μm was produced in the same way as in Example 2, except that 0.4 g of aromatic polyisocyanate (product name: “CORONATE L” made by NIPPON POLYURETHANE INDUSTRY CO., LTD., solid content: 75%) was used.

### Comparative Example 4

A double-sided pressure-sensitive adhesive tape having a total thickness of 60 μm was produced in the same way as in Example 2, except that a pressure-sensitive adhesive, obtained by adding 6.9 g of terpene phenol resin (product name: “YS Polystar S-145” made by YASUHARA CHEMICAL CO., LTD., solid content: 100%) and 1.4 g of aromatic polyisocyanate (product name: “CORONATE L” made by NIPPON POLYURETHANE INDUSTRY CO., LTD., solid content: 75%) to 100 g of the acrylic copolymer IV.

### Comparative Example 5

A double-sided pressure-sensitive adhesive tape having a total thickness of 60 μm was produced in the same way as in Example 2, except that a pressure-sensitive adhesive, obtained by adding 1.1 g of aromatic polyisocyanate (product name: “CORONATE L” made by NIPPON POLYURETHANE INDUSTRY CO., LTD., solid content: 75%) to 100 g of the acrylic copolymer V, was used.

### Comparative Example 6

A double-sided pressure-sensitive adhesive tape having a total thickness of 160 μm was produced in the same way as in Example 1, except that: a film substrate (product name: “Lumirror #25S105” made by TORAY INDUSTRIES having a thickness of 25 μm) was used as a substrate; and the pressure-sensitive adhesive was coated such that the dried coating thickness on both surfaces was 67.5 μm.

### Comparative Example 7

A double-sided pressure-sensitive adhesive tape having a total thickness of 60 μm was produced in the same way as in Example 2, except that the rubber pressure-sensitive adhesive I was used as the pressure-sensitive adhesive.

### Comparative Example 8

A double-sided pressure-sensitive adhesive tape having a total thickness of 60 μm was produced in the same way as in Example 2, except that a pressure-sensitive adhesive, which was obtained by adding 34.2 g of aqueous dispersion type rosin resin (product name: “KE-802” made by Arakawa Chemical Industries, Ltd., solid content: 50.1%) to 100 g of the acrylic pressure-sensitive adhesive IV and the viscosity of which was adjusted to 10 Pa*S by using a polyacrylic acid as a thickener, was used.

The double-sided pressure-sensitive adhesive tapes obtained in the aforementioned ways were presented for the following evaluation tests. The obtained results are shown in Tables 1 and 2.

### [Pressure-Sensitive Adhesive Force]

The pressure-sensitive adhesive tape was backed up by peeling off the release liner on one surface of the tape (on the side of the PET separator having a thickness of 38 μm) and by attaching the one surface thereof to a polyethylene terephthalate (PET) film having a thickness of 25 μm. A specimen was produced by cutting the backed-up pressure-sensitive adhesive tape into a piece having a size of 5 mm in width×100 mm in length. After the release liner on the other surface of the specimen was peeled off, the specimen was pressure-attached to an adherend by reciprocating a 2-kg roller once. One surface of an ITO film (product name: “V270L-TFMP” made by NITTO DENKO CORPORATION), the surface having been subjected to a heat treatment at 140° C. for 9 hours, was used as the adherend. When the specimen was not dipped in artificial sebum, an pressure-sensitive adhesive force A (N/5 mm) was measured by pulling, after a lapse of 72 hours since the attachment, the specimen by using a tensile tester a tensile speed of 300 mm/min and a tensile angle of 180° under a measurement environment of 23°×50% RH. When the specimen was dipped in artificial sebum, this attached specimen was dipped in the artificial sebum at 55° C. for 72 hours. After the dipping, the artificial sebum adhered to the surfaces of the specimen was fully wiped off and the specimen was then left uncontrolled under the measurement environment of 23° C.×50% RH for 1 hour. Thereafter, a pressure-sensitive adhesive force B (N/5 mm) was measured by using a tensile tester at a tensile speed of 300 mm/min and tensile angle of 180°.

### [Oil Absorption]

An oil absorption was measured in the method described in the aforementioned [Method of Calculating Oil Absorption]. A mixture having the following composition was used as the artificial sebum:

artificial sebum: 33.3% by mass of triolein; 20.0% by mass of oleic acid; 13.3% by mass of squalene; and 33.4% by mass of myristyl octadecylate.

### [Thickness]

The thickness of a specimen, the oil absorption of which was to be measured, was measured by using a 1/1000 dial gauge before and after dipping.

TABLE 1

| | | EXAMPLE 1 | EXAMPLE 2 | EXAMPLE 3 | EXAMPLE 4 | EXAMPLE 5 |
|---|---|---|---|---|---|---|
| PRESSURE- | BEFORE DIPPING | 3.8 | 2.4 | 2.8 | 3.3 | 3.2 |
| SENSITIVE | IN SEBUM (A) | | | | | |
| ADHESIVE | AFTER DIPPING | 2.9 | 2.2 | 2.7 | 2.8 | 2.6 |
| FORCE | IN SEBUM (B) | | | | | |
| (N/5 mm) | B/A | 0.76 | 0.92 | 0.96 | 0.85 | 0.81 |
| OIL ABSORPTION (% BY MASS) | | 32.0 | 63.1 | 43.2 | 39.9 | 39.2 |
| THICKNESS | BEFORE DIPPING | 80.0 | 60.0 | 60.0 | 60.0 | 60.0 |
| (μm) | IN SEBUM | | | | | |
| | AFTER DIPPING | 98.8 | 79.5 | 78.7 | 77.1 | 76.7 |
| | IN SEBUM | | | | | |
| | AMOUNT OF | 18.8 | 19.5 | 18.7 | 17.1 | 16.7 |
| | CHANGE | | | | | |

TABLE 2

| | | COMPARATIVE | COMPARATIVE | COMPARATIVE | COMPARATIVE |
|---|---|---|---|---|---|
| | | EXAMPLE 1 | EXAMPLE 2 | EXAMPLE 3 | EXAMPLE 4 |
| PRESSURE- | BEFORE DIPPING | 4.0 | 3.5 | 3.1 | 3.8 |
| SENSITIVE | IN SEBUM (A) | | | | |
| ADHESIVE | AFTER DIPPING | 2.1 | 2.4 | 2.6 | 1.6 |
| FORCE | IN SEBUM (B) | | | | |
| (N/5 mm) | B/A | 0.53 | 0.69 | 0.84 | 0.42 |
| OIL ABSORPTION (% BY MASS) | | 325.1 | 409.1 | −15.4 | 236.6 |
| THICKNESS | BEFORE DIPPING | 80.0 | 60.0 | 60.0 | 60.0 |
| (μm) | IN SEBUM | | | | |
| | AFTER DIPPING | 301.0 | 256.9 | 50.2 | 172.9 |
| | IN SEBUM | | | | |
| | AMOUNT OF | 221.0 | 196.9 | −9.8 | 112.9 |
| | CHANGE | | | | |
| | | COMPARATIVE | COMPARATIVE | COMPARATIVE | COMPARATIVE |
| | | EXAMPLE 5 | EXAMPLE 6 | EXAMPLE 7 | EXAMPLE 8 |
| PRESSURE- | BEFORE DIPPING | 2.1 | 4.5 | 2.2 | 3.7 |
| SENSITIVE | IN SEBUM (A) | | | | |
| ADHESIVE | AFTER DIPPING | 0.9 | 3.2 | 0.3 | 0.4 |
| FORCE | IN SEBUM (B) | | | | |
| (N/5 mm) | B/A | 0.43 | 0.71 | 0.14 | 0.11 |
| OIL ABSORPTION (% BY MASS) | | 169.8 | 32.0 | — | — |
| THICKNESS | BEFORE DIPPING | 60.0 | 160.0 | 60.0 | 60.0 |
| (μm) | IN SEBUM | | | | |
| | AFTER DIPPING | 140.4 | 188.0 | 25.0 | 27.0 |
| | IN SEBUM | | | | |
| | AMOUNT OF | 80.4 | 28.0 | −35.0 | −33.0 |
| | CHANGE | | | | |

The oil absorption of each of Comparative Examples 7 and 8 was not able to be measured, because the artificial sebum was not able to be wiped off due to elution of and remarkable plasticization of the pressure-sensitive adhesive layer after the dipping in the sebum.

In the double-sided pressure-sensitive adhesive tape of each Example shown in Table 1, an oil adsorption is within a range of 10% by mass to 150% by mass, and a change in thickness is less than 20 μm. Further, in the double-sided pressure-sensitive adhesive tape of each Example, the ratio of B/A is 0.4 or larger, and hence it has been confirmed that a decrease in pressure-sensitive adhesive force is suppressed. As stated above, it has been confirmed that, in the double-sided pressure-sensitive adhesive tape of each Example, a change in the depth-wise dimension and a change in pressure-sensitive adhesive force are small even when dipped in oil.

On the other hand, in the double-sided pressure-sensitive adhesive tape of each of Comparative Examples 1, 2, 4, and 5, shown in Table 2, an oil absorption is 150% by mass or more, and also a change in the thickness is greatly large than 20 μm. Also, in the double-sided pressure-sensitive adhesive tape of each of Comparative Examples 1, 2, 4, and 5, the ratio of B/A is smaller than 0.4 and a decrease in pressure-sensitive adhesive force is remarkable. In the double-sided pressure-sensitive adhesive tape of each of Comparative Examples 3, 7, and 8, it has also been confirmed that the pressure-sensitive adhesive layer is eluted due to the dipping in the artificial sebum. It has been confirmed that, in the double-sided pressure-sensitive adhesive tape of Comparative Example 6, an oil absorption is small, but a change in the depth direction becomes larger than 20 μm because the thickness of the tape is large.

The present invention is not limited to the aforementioned embodiments, and various modifications, such as design modifications, can be added based on the knowledge of those skilled in the art, and an embodiment in which such a modification is added can be included in the scope of the present invention.

What is claimed is:

1. A double-sided pressure-sensitive adhesive tape to be used in an application of fixing a member in a portable electronic device, the double-sided pressure-sensitive adhesive tape comprising:
a solvent-type acrylic copolymer, wherein
the total thickness of the double-sided pressure-sensitive adhesive tape is 150 μm or less and a mass increase after being dipped in artificial sebum under an atmosphere at 55° C. for 3 days is 10% by mass or more and 150% by mass or less.

2. The double-sided pressure-sensitive adhesive tape according to claim 1, wherein
the weight average molecular weight of the solvent-type acrylic copolymer is 400000 or more and 700000 or less.

3. The double-sided pressure-sensitive adhesive tape according to claim 1, wherein
when it is assumed that: a pressure-sensitive adhesive force (N/5 mm) of the double-sided pressure-sensitive adhesive tape is A, the force occurring when the tape is peeled off in the 180°-peeling off direction at a tensile speed of 300 mm/min after a lapse of 72 hours at 23° C.×50% RH, in a state of not being dipped in the artificial sebum, after being adhered to a transparent conductive film that serves as an adherend; and a pressure-sensitive adhesive force (N/5 mm) of the tape is B, the force occurring when the tape is peeled off in the 180°-peeling off direction at a tensile speed of 300 mm/min after a lapse of 1 hour at 23° C.×50% RH after the artificial sebum is wiped off, in which the tape has been dipped at 55° C. for 72 hours after being attached to a transparent conductive film that serves as an adherend, B/A is 0.4 or larger.

4. The double-sided pressure-sensitive adhesive tape according to claim 1 to be used for adhesion of a transparent conductive film.

5. The double-sided pressure-sensitive adhesive tape according to claim 2, wherein
when it is assumed that: a pressure-sensitive adhesive force (N/5 mm) of the double-sided pressure-sensitive adhesive tape is A, the force occurring when the tape is peeled off in the 180°-peeling off direction at a tensile speed of 300 mm/min after a lapse of 72 hours at 23° C.×50% RH, in a state of not being dipped in the artificial sebum, after being adhered to a transparent conductive film that serves as an adherend; and a pressure-sensitive adhesive force (N/5 mm) of the tape is B, the force occurring when the tape is peeled off in the 180°-peeling off direction at a tensile speed of 300 mm/min after a lapse of 1 hour at 23° C.×50% RH after the artificial sebum is wiped off, in which the tape has been dipped at 55° C. for 72 hours after being attached to a transparent conductive film that serves as an adherend, B/A is 0.4 or larger.

6. The double-sided pressure-sensitive adhesive tape according to claim 2 to be used for adhesion of a transparent conductive film.

7. The double-sided pressure-sensitive adhesive tape according to claim 3 to be used for adhesion of a transparent conductive film.

8. The double-sided pressure-sensitive adhesive tape according to claim 5 to be used for adhesion of a transparent conductive film.
